(19) United States
(12) Patent Application Publication
(10) Pub. No.: US 2023/0373253 A1
(43) Pub. Date: Nov. 23, 2023

(54) Tire with Improved Grip for a Heavy Civil Engineering Vehicle

(71) Applicant: COMPAGNIE GENERALE DES ETABLISSEMENTS MICHELIN, Clermont-Ferrand (FR)

(72) Inventors: William LICENSE, Clermont-Ferrand Cedex 9 (FR); Francois BARBARIN, Clermont-Ferrand Cedex 9 (FR)

(21) Appl. No.: 18/027,871

(22) PCT Filed: Sep. 22, 2021
(86) PCT No.: PCT/FR2021/051619

§ 371 Date: Mar. 22, 2023

(30) Foreign Application Priority Data
Sep. 23, 2020 (FR) FR2009632

(51) Int. Cl. B60C 11/03

(52) U.S. Cl. CPC B60C 11/033; B60C 11/0306; B60C 2200/065

(57) ABSTRACT

A tire (1) for a heavy vehicle of construction plant type and aims to improve the performance compromise between its lifetime in terms of wear, its resistance to attack and its grip. With the tread (2) having an axial width L0 and, on each side of an equatorial plane (XZ), at least one outer longitudinal cut (41) at an axial distance LE at least equal to 0.5*L0/2, and at least one inner longitudinal cut (42) at an axial distance LI at most equal to 0.4*L0/2, the at least one outer longitudinal cut (41) with an outer radial portion (411) that opens onto the tread surface (3) and has a mean width WE1 at least equal to 0.6 times its height HE1, and the at least one inner longitudinal cut (42) has an inner radial portion (422) that does not open onto the tread surface (3) and has a mean width WI2 at least equal to 0.6 times its height HI2.

The present invention relates to a tire for a heavy vehicle of construction plant type, which is intended to carry heavy loads and to run over uneven and stony ground such as that of mines. This invention relates in particular to the tread of such a tire, the grip of which is improved throughout its use.

The invention relates more particularly to a tire intended to be fitted to a heavy vehicle of construction plant type, such as a dumper intended for transporting materials extracted from quarries or surface mines. A dumper is subjected to particularly harsh running conditions: high loads, sustained speeds, sloping and winding routes, uneven and stony ground. By way of example, on sites at which materials, such as ores or coal, are extracted, the use of a vehicle of the dumper type consists, in simplified form, of an alternation of laden outbound cycles and of unladen return cycles. In a laden outbound cycle, the laden vehicle transports the extracted materials, mainly uphill, from the loading zones at the bottom of the mine, or the bottom of the pit, to unloading zones, thereby requiring that the tires have good grip in traction. In an unladen return cycle, the unladen vehicle returns, mainly downhill, towards the loading zones at the bottom of the mine, thereby requiring good tire grip under braking. The often sloping tracks are also often winding, thereby requiring that the tires have good transverse grip. Furthermore, the tracks on which the vehicles run are made up of materials generally taken from the mine, for example crushed and compacted rocks, in order to ensure the integrity of the wearing layer of the track as the vehicles pass over it, the rocks being regularly damped down, meaning that they are often covered with mud and water. Consequently, it is necessary to allow, on the one hand, effective removal of this mixture of mud and water by the tread, in order to ensure satisfactory grip on muddy ground, and, on the other hand, good resistance to wear and to attack by the stones present on the ground.

The specific use of a dumper, as described above, entails particular management of the tires fitted thereto. In the new state, a tire is usually fitted to the front axle, or steering axle, of the vehicle. At this front position, the load applied to the tire is generally estimated to be between 80% and 100% of its nominal load-bearing capacity, depending on whether the vehicle is running in an unladen or laden state, as defined, for example, by the standard ISO 4250 and the standard of the “Tire and Rim Association” or TRA. When the tire reaches around one third of its wear, meaning that the initial height in the new state of its tread has been reduced by one third, the tire is removed from the front axle and is fitted to a rear axle, or driven axle, of the vehicle. At this rear position, the load applied to the tire is generally estimated to be between 25% and 100% of its nominal load-bearing capacity, depending on whether the vehicle is running in an unladen or laden state. Lastly, the tire is permanently removed from the driven axle when its tread reaches a residual height corresponding to a completely worn state in accordance with the prevailing practice.

A tire tread, intended to constitute the peripheral part of of the tire, comprises at least one rubber-based material and is intended to wear down when it comes into contact with the ground via a tread surface.

The following definitions apply in the following text:
radial direction: a direction perpendicular to the axis of rotation of the tire,
axial or transverse direction: a direction parallel to the axis of rotation of the tire,
circumferential or longitudinal direction: a direction tangential to the periphery of the tire and perpendicular to the radial and axial directions, respectively,
equatorial or median circumferential plane: a plane containing the radial direction and the circumferential direction, perpendicular to the axis of rotation of the tire and dividing the tire into two equal portions.

The tread, integrated into the tire, is usually characterized geometrically by an axial width L, along the axial direction, and a radial thickness E, along a radial direction. The axial width L is defined as being the axial width of the tread surface portion, in contact with smooth ground, the tire being mounted on a recommended rim and subjected to given pressure and load conditions. The radial thickness E is defined, by convention, as being the maximum depth Dmax measured in the cuts. In the case of a tire in the new state for a vehicle of construction plant type, and by way of example, the axial width L is at least equal to 600 mm and the maximum depth Dmax is at least equal to 60 mm, or even 70 mm. However, these characteristics of axial width L and maximum depth Dmax depend on the state of wear of the tire. In particular, the maximum depth Dmax varies between an initial depth D0, in the new state of the tire, and a residual depth DR, in the worn state of the tire, at which value the tire is removed from the vehicle in accordance with the prevailing practice.

To ensure a satisfactory longitudinal grip performance, under engine torque and braking torque, and transverse grip performance, it is necessary to form, in the tread, a tread pattern which is a system of cuts separating raised elements.

A cut is a space that is delimited by walls of material that face one another and are spaced apart from one another by a distance defining the width of the cut, and extends from the tread surface, along the radial direction, over a given height. Depending on the value of its width, a cut is either a sipe or a groove. In the case of a sipe, this width is suitable for allowing the opposing walls delimiting said sipe to come into at least partial contact at least in the contact patch in which the tread is in contact with the ground, when the tire is under nominal load and pressure conditions recommended, for example, by the TRA standard. In the case of a groove, the walls of this groove do not generally come into contact with one another under these recommended nominal running conditions.

The cuts delimit raised elements of the block or rib type. A block comprises a contact face, contained in the tread surface, and at least three, and usually four, lateral faces intersecting the tread surface. A rib comprises a contact face and two lateral walls that extend, along the circumferential direction, along the entire length of the tread. A rib is thus delimited, along the circumferential direction, by one or two circumferential cuts.

The proportion of cuts contained in the tread or in a tread portion can be defined by a volumetric void ratio TEV or by a surface-area void ratio TES.

By definition, the volumetric void ratio TEV of the tread is equal to the ratio between the total volume VD of the cuts, measured on the free tire, i.e. when it is not mounted and not inflated, and the sum of the total volume VD of the cuts and the total volume VR of the raised elements delimited by these cuts. The sum VD+VR corresponds to the volume contained radially between the tread surface and a bottom surface, translated from the tread surface radially towards the inside by a radial distance equal to the maximum depth Dmax of the tread. This volumetric void ratio TEV, expressed in %, governs the wearing performance, in terms of the wearable material available, and the longitudinal and transverse grip performance, in terms of the presence of respectively transverse and longitudinal edge corners and of cuts capable of storing or removing water and/or mud.

By definition, the surface-area void ratio TES of the tread is defined in the contact surface area of the tire with rigid ground, when the tire, mounted on its nominal rim, is inflated to its nominal pressure and compressed under its nominal load, these nominal characteristics being recommended, for example, by the TRA standard. This surface-area void ratio TES is equal to the ratio between the total surface area SD of the cuts and the sum of the total surface area SD of the cuts and the total surface area SR of the raised elements delimited by these cuts, the surface areas SD and SR being determined in the contact surface area. The sum SD+SR corresponds to the contact surface area. This surface-area void ratio TES, expressed in %, governs the wearing performance, in terms of the surface area of material in contact with the ground impacting the distribution of the pressures exerted by the ground on the tread surface, and the longitudinal and transverse grip performance, in terms of the length of respectively transverse and longitudinal edge corners governing the effectiveness of the indentation of the tread pattern.

This volumetric void ratio TEV and this surface-area void ratio TES can be determined either in the new state of the tread, before the tire is used for running, or in a given state of wear of the tread, characterized by a remaining depth of the tread.

A tread of a tire for a vehicle of construction plant type usually comprises grooves, which may be longitudinal or transverse. A longitudinal groove has a mean line that forms an angle of less than 45° with the longitudinal direction of the tire. A transverse groove has a mean line that forms an angle of more than 45° with the longitudinal direction of the tire. Generally, the width of a groove decreases gradually from the tread surface to the bottom of the groove, on account of the inclination of the walls of the raised elements delimiting said grooves. Consequently, the volumetric void ratio decreases when the tire passes from a new state to a worn state. For example, to ensure a volumetric void ratio equal to around 8% at the end of life of the tire, when the latter is completely worn, the corresponding volumetric void ratio in the new state needs to be at least equal to around 22%. However, a high volumetric void ratio in the new state has a number of drawbacks. First of all, it encourages the capture and retention of stones in the grooves, these being likely to damage the crown of the tire by way of the cracks that they potentially bring about. Next, a high volumetric void ratio in the new state implies a surface-area void ratio that is likewise high, and therefore a somewhat smaller contact surface area of the raised elements with the ground, and, consequently, strong pressures on the ground, which enhance the phenomenon of abrasion of the tread and therefore the wearing thereof. Lastly, a high volumetric void ratio in the new state allows lateral deformations, referred to as “barrel-shaped” deformations, of the raised elements, by the Poisson effect, thereby reducing the effective volume of the grooves, characterizing their capacity for storing and removing water or muddy mixture, resulting in a loss of grip of the tire on muddy ground. However, these Poisson effect deformations tend to decrease when the wearing of the tread increases, on account of the reduction in the height of the raised elements.

A satisfactory compromise between the performance aspects of resistance to attack, of lifetime in terms of wear and of grip on wet or muddy ground is therefore difficult to find. For this reason, tire manufacturers have hitherto chosen to prioritize one or two given performance aspects. For example, the performance in terms of grip on wet or muddy ground has been able to be prioritized over the lifetime in terms of wear and the resistance to attack. According to this first option, the Michelin 24.00 R 35 XTRA LOAD GRIP range provides a tread pattern, referred to as open, comprising, in a median portion and in the two lateral portions that continue it, a network of wide longitudinal and transverse grooves that make it possible to capture mud over the entire tread surface and to remove it at least partially via transverse grooves that open out at the edges of the tread. In another example, the performance aspects of lifetime in terms of wear and of resistance to attack have been able to be prioritized over grip. According to this second option, the Michelin 24.00 R 35 XTRA LOAD GRIP range provides a tread pattern that is more closed in a median portion, meaning that it comprises narrow longitudinal and transverse grooves that guarantee a volume of material to be worn down and protects against attack, and more open in the two lateral portions that continue the median portion, meaning that it comprises in each case transverse grooves that open onto the edges of the tread, for the at least partial removal of the water or muddy mixture.

The inventors have set themselves the objective of designing a tread for a tire of a heavy vehicle of construction plant type that makes it possible to improve the performance compromise between lifetime in terms of wear, resistance to attack and grip, when it is used on tracks that may be covered with water and mud, while ensuring the durability of grip throughout the lifetime of the tire.

This objective has been achieved, according to the invention, by a tire for a heavy vehicle of construction plant type comprising, in a new state before it is driven on, a tread intended to come into contact with the ground via a tread surface:
the tread surface having an axial width L0 when the tire mounted on a nominal rim is inflated to a nominal pressure Pn and compressed under a nominal load Zn,
the tread comprising cuts that separate raised elements and have a maximum depth D0,
the tread comprising, on each side of an equatorial plane, at least one outer longitudinal cut having a mean line positioned, with respect to an equatorial plane of the tire, at an axial distance LE at least equal to 0.5*L0/2, and at least one inner longitudinal cut having a mean line positioned, with respect to the equatorial plane of the tire, at an axial distance LI at most equal to 0.4*L0/2,
the at least one outer longitudinal cut comprising an outer radial portion that opens onto the tread surface and has a height HE1 and a mean width WE1 at least equal to 0.6 times the height HE1,
and the at least one inner longitudinal cut comprising an inner radial portion that does not open onto the tread surface, extends at least in part radially on the inside of the outer radial portion of the outer longitudinal cut, and has a height HI2 and a mean width WI2 at least equal to 0.6 times the height HI2.

The principle of the invention is to provide a tire for a heavy vehicle of construction plant type, the grip of which, more particularly on wet and/or muddy ground, is ensured at any level of wear of the tread, between a new state characterized by a maximum depth D0 and a worn state characterized, for example, in accordance with the prevailing practice, by a maximum depth DR at least equal to D0/10, specifically regardless of the level of load applied to the tire, between 25% and 100% of its recommended load Zn. 25% Zn corresponds to the load applied to a tire fitted to a rear axle of an unladen vehicle, and 100% Zn corresponds to the load applied to a tire fitted to a front or rear axle of a fully laden vehicle.

When the vehicle is fully laden, regardless of the position of the tire on the vehicle, on a front or rear axle, the tire mounted on a nominal rim is inflated to a nominal pressure Pn and compressed under a nominal load Zn, as are defined, for example, by the standard ISO 4250 and the standard of the “Tire and Rim Association” or TRA. Under these conditions, the tread surface of the tire comes into contact with ground that is presumed to be smooth, over a laden contact surface area having an axial width L0, measured between the axial ends of said laden contact surface area.

When the vehicle is unladen and the tire is fitted to a rear axle, the tire mounted on a nominal rim is inflated to a nominal pressure Pn and compressed under a load equal to around 0.25*Zn. Under these conditions, the tread surface of the tire comes into contact with ground that is presumed to be smooth, over an unladen contact surface area having an axial width L1, measured between the axial ends of said unladen contact surface area. The axial width L1 is less than the axial width L0.

Between these two extreme loadings, respectively laden on any type of axle and unladen on a rear axle, there is an intermediate case in which, when the tire is fitted to a front axle of an unladen tire, the tire mounted on a nominal rim is inflated to a nominal pressure Pn and compressed under a load equal to 0.8*Zn, more generally at least equal to 0.75*Zn and at most equal to 0.85*Zn.

The tread comprises cuts that separate raised elements and have a maximum depth D0. D0 is the maximum depth of the cut in the new state, meaning the maximum distance between the radially inner point of the deepest cut and the tread surface in the new state. D0 makes it possible to define a theoretical bottom surface parallel to the tread surface and a maximum thickness of tread intended to be worn down. D0 is the reference on the basis of which the various states of wear of the tread are defined, which are each characterized by a maximum depth Dmax that can be expressed in a percentage of D0.

The tread comprises more particularly, on each side of an equatorial plane, at least one outer longitudinal cut having a mean line positioned, with respect to an equatorial plane of the tire, at an axial distance LE at least equal to 0.5*L0/2, and at least one inner longitudinal cut having a mean line positioned, with respect to the equatorial plane of the tire, at an axial distance LI at most equal to 0.4*L0/2.

A longitudinal cut is understood to be a cut of which the mean line forms an angle at most equal to 45° with the circumferential direction of the tire. Either the mean line forms a zero angle and is strictly longitudinal, or it comprises at least one oblique portion forming a non-zero angle, such as, for example, in the case of a cut oscillating about the circumferential direction.

An outer longitudinal cut having a mean line positioned, with respect to an equatorial plane of the tire, at an axial distance LE at least equal to 0.5*L0/2 is a longitudinal cut extending on the outside of the unladen contact surface area. In other words, the mean line of said outer longitudinal cut is axially positioned, with respect to the equatorial plane of the tire, at an axial distance LE greater than the axial half-width L1/2 of the unladen contact surface area increased by the mean half-thickness WE1 of said outer longitudinal cut. An outer longitudinal cut is therefore in contact with the ground in the case of a tire fitted to a laden vehicle or on the front axle of an unladen vehicle, but is not in the case of a tire fitted to a rear axle of an unladen vehicle.

An inner longitudinal cut having a mean line positioned, with respect to the equatorial plane of the tire, at an axial distance LI at most equal to 0.4*L0/2 is a longitudinal cut extending on the inside of the unladen contact surface area. In other words, the mean line of said inner longitudinal cut is axially positioned, with respect to the equatorial plane of the tire, at an axial distance LI less than the axial half-width L1/2 of the unladen contact surface area decreased by the mean half-thickness WI1 of said inner longitudinal cut. An inner longitudinal cut is therefore in contact with the ground in the case of a tire fitted to a laden vehicle and also in the case of a tire fitted to a rear axle of an unladen vehicle.

According to a first essential feature of the invention, the at least one outer longitudinal cut comprises an outer radial portion that opens onto the tread surface and has a height HE1 and a mean width WE1 at least equal to 0.6 times the height HE1.

The height HE1 is measured between the radially outermost point of the radially outer portion, said point being positioned on the tread surface in the new state, and the radially innermost point of the radially outer portion. The mean width WE1 is the average of the outer radial portion widths over the entire height HE1, a width being measured, at a given level, between the facing walls of material defining the outer radial portion of a cut. A mean width WE1 at least equal to 0.6 times the height HE1 implies that the outer radial portion is a groove referred to as effective. A groove is cut that is sufficiently wide for its walls generally not to come into contact with one another under the recommended nominal running conditions. In addition, it is referred to as effective since its cross section is not reduced substantially, on account of the deformations of the adjacent raised elements, by the Poisson effect.

The cross section of the open outer radial portion thus remains sufficiently open to allow storage and removal of the water or mud present on the ground, and therefore to ensure the required grip. Consequently, the presence of an outer longitudinal cut, with an outer radial portion of the open and effective groove type, ensures removal of the water and the mud for a tire in the new, i.e. unworn, state and fitted to a front axle of a fully laden vehicle.

According to a second essential feature of the invention, the at least one inner longitudinal cut comprises an inner radial portion that does not open onto the tread surface, extends at least partially radially on the inside of the outer radial portion of the outer longitudinal cut, and has a height HI2 and a mean width WI2 at least equal to 0.6 times the height HI2.

The height HI2 is measured between the radially outermost point of the inner radial portion, said point being situated radially on the inside of the tread surface, and the radially innermost point of the inner radial portion. The mean width WI1 is the average of the outer radial portion widths over the entire height HI2. A mean width WI2 at least equal to 0.6 times the height HI2 implies that the inner radial portion is a groove referred to as effective, as described above. Unlike the outer longitudinal cut, the inner longitudinal cut comprises an inner radial portion that does not open onto the tread surface of the tire in the new state, meaning that it opens onto the latter only from an intermediate state of wear. In other words, this inner radial portion is hidden in the new state and down to an intermediate state of wear. This intermediate state of wear corresponds generally to the level of wear for which the tire fitted initially to a front axle of the vehicle is transferred onto a rear axle. Moreover, this inner radial portion extends at least partially radially on the inside of the outer radial portion of the outer longitudinal cut. In other words, the radially innermost point of the inner radial portion of the inner longitudinal cut is radially inside the radially innermost point of the outer radial portion of the outer longitudinal cut. Consequently, there is a partial, but not full overlap, or even no overlap, between the inner radial portion of the inner longitudinal cut and the outer radial portion of the outer longitudinal cut.

Consequently, the effectiveness of the inner longitudinal cut, with respect to the removal of water or mud, only occurs from a certain level of partial wear of the tire and, where appropriate, until it is fully worn down. Thus, the presence of an inner longitudinal cut, with an inner radial portion of the effective groove type that is open starting from a certain level of wear, ensures removal of the water and the mud for a tire in an intermediate state of wear that may go down to a state of total wear, and fitted to a rear axle of an unladen vehicle.

Advantageously, the outer radial portion of the at least one outer longitudinal cut has a mean width WE1 at most equal to 2 times the height HE1, preferably at most equal to the height HE1. If the mean width WE1 is increased to more than 2 times the height HE1, the laden contact surface area decreases and therefore the contact pressures increase, entailing an increase in wear.

Preferably, the outer radial portion of the at least one outer longitudinal cut extends radially inwards down to a radial depth DE1 at least equal to D0/4, preferably at least equal to D0/3. The radial depth DE1 corresponds to the radial distance between the tread surface in the new state and the radially innermost point of the outer radial portion. The radial depth DE1 is therefore equal to the height HE1, since the outer radial portion is open, in the new state. Consequently, the outer radial portion is an effective groove at least down to a quarter of the wearing of the thickness of the tread, corresponding to a remaining maximum cut depth equal to 3*D0/4, preferably at least down to one third of the wear, corresponding to a remaining maximum cut depth equal to 2*D0/3.

Likewise preferably, the outer radial portion of the at least one outer longitudinal cut extends radially inwards down to a radial depth DE1 at most equal to 2*D0/3, preferably at most equal to D0/2. Consequently, the outer radial portion is an effective groove at most down to two thirds of the wear, corresponding to a remaining maximum cut depth equal to D0/3, preferably down to half of the wearing of the thickness of the tread, corresponding to a remaining maximum cut depth equal to D0/2.

Preferably, the meridian section of the outer radial portion of the at least one outer longitudinal cut is constant along the circumferential direction, ensuring a rate of removal of the water or the muddy mixture that is constant around the entire circumference of the tire.

Also preferably, the outer radial portion of the at least one outer longitudinal cut has a circular circumferential mean line centred on the axis of rotation of the tire. Consequently, this outer radial portion does not undulate, along the circumferential direction, in the thickness of the tread.

Also preferably, the at least one outer longitudinal cut comprises an inner radial portion that opens into its outer radial portion and has a height HE2 and a mean width WE2 at most equal to 0.2 times the height HE2. A mean width WE2 at most equal to 0.2 times the height HE2 implies that the inner radial portion is a sipe, meaning a cut that is sufficiently narrow for its walls to come into contact with one another under the recommended nominal running conditions. This sipe is not open in the new state. When the level of wear opens up this sipe, meaning beyond the radial depth DE1, this does not make it possible to remove water or mud but contributes to grip, under transverse loadings, through an effect of indentation of the open edge corners of its walls. Moreover, the sipe that has been opened up allows a local increase in the flexibility of the tread, in its axially outer portion, thereby promoting the flattening of the tire. Moreover, it makes it possible to limit the sliding deformations, on account of the independence of the raised elements that delimit it. Effective flattening and limiting of the sliding deformations make it possible to slow down wear. Lastly, a sipe allows the removal of heat energy, and therefore a reduction in the temperature of the crown of the tire, this being favourable for the durability of this crown.

Advantageously, the inner radial portion of the at least one inner longitudinal cut has a mean width WI2 at most equal to 2 times the height HI2, preferably at most equal to the height HI2. When the inner radial portion is opened up, if the mean width WI2 is increased to more than 2 times the height HI2, the unladen contact surface area decreases and therefore the contact pressures increase, entailing an increase in wear.

Preferably, the inner radial portion of the at least one inner longitudinal cut extends radially inwards down to a radial depth DI2 at least equal to D0/2, preferably at least equal to 2*D0/3. The radial depth DI2 corresponds to the radial distance between the tread surface in the new state and the radially innermost point of the inner radial portion. The radial depth DI2 is not equal to the height HI2, since the inner radial portion is not open, in the new state. Consequently, the inner radial portion is an effective groove at least down to half of the wearing of the thickness of the tread, corresponding to a remaining maximum cut depth equal to D0/2, preferably at least down to two thirds of the wear, corresponding to a remaining maximum cut depth equal to D0/3.

Likewise preferably, the inner radial portion of the at least one inner longitudinal cut extends radially inwards down to a radial depth DI2 at most equal to D0. Consequently, the inner radial portion is an effective groove at most down to total wearing of the thickness of the tread, corresponding to a maximum cut depth equal to D0. Preferably, the inner radial portion of the or each inner longitudinal cut extends radially inwards down to a radial depth DI2 at most equal to 9*D0/10, and even more preferably at most equal to 3*D0/4.

Preferably, the meridian section of the inner radial portion of the at least one inner longitudinal cut is constant along the circumferential direction, ensuring a rate of removal of the water or muddy mixture that is constant around the entire circumference of the tire.

Also preferably, the inner radial portion of the at least one inner longitudinal cut has a circular circumferential mean line centred on the axis of rotation of the tire. Consequently, this inner radial portion does not undulate, along the circumferential direction, in the thickness of the tread.

Also preferably, the at least one inner longitudinal cut comprises an outer radial portion that opens onto the tread surface and into its inner radial portion and has a height HI1 and a mean width WI1 at most equal to 0.2 times the height HI1. As shown above, in the case of an outer longitudinal cut, this outer radial portion is an open sipe that has a favourable impact on grip, wear and the thermal endurance of the crown. Moreover, it has a technological advantage in relation to the production of the tread pattern, allowing the moulding and demoulding of the inner radial portion of the non-open groove type to which it is linked.

According to one particular embodiment, the inner radial portion of the at least one inner longitudinal cut is continued radially towards the inside by a complementary inner radial portion having a height HI3 and a mean width WI3 at most equal to 0.2 times the height HI3. When the radial depth DI2 of the inner radial portion of the inner longitudinal cut is significantly less than D0, preferably than 9*D0/10, this inner radial portion of the effective groove type may itself be continued radially towards the inside by a complementary inner radial portion of the sipe type, down to a depth at most equal to D0, preferably at most equal to 9*D0/10.

According to another particular embodiment, the tread comprises two inner longitudinal grooves, the respective inner radial portions of which are offset radially with respect to one another in the thickness of the tread. The effective radial portions of the outer longitudinal groove and of the inner longitudinal grooves thus form a stepped arrangement of three effective radial portions that overlap at least in part radially, in pairs.

With the tire having an outside diameter D, measured in the equatorial plane, and a laden contact surface area having a circumferential length C0 when the tire mounted on a nominal rim is inflated to a nominal pressure Pn and compressed under a nominal load Zn, the at least one outer longitudinal cut is preferably connected to at least NE outer transverse cuts that open out at an axial end of the tread, NE being at least equal to Π*D/C0, such that the laden contact surface area comprises at least one outer transverse cut. A transverse cut is understood to be a cut of which the mean line forms an angle at most equal to 45° with the circumferential direction of the tire. Either the mean line forms an angle equal to 90° and is strictly transverse, or it comprises at least one oblique portion forming an angle strictly less than 90°.

As described above, each outer longitudinal cut makes it possible, by way of its outer radial portion, to remove the water and the mud that may be present on the ground, along the circumferential direction, when the tire is fitted to the front axle of the vehicle, for a new state or a state at the start of wear. In addition to this longitudinal removal, each outer longitudinal cut is connected to a set of transverse cuts referred to as outer transverse cuts, which have the function of ensuring lateral removal of the water and the mud, at lateral edges of the tread, usually referred to as shoulders. However, this lateral removal requires the presence of at least one such outer transverse cut opening into the laden contact surface area. This minimum presence is ensured by a regular circumferential distribution, but not necessarily at a constant spacing, of NE outer transverse cuts, where NE is at least equal to Π*D/C0, where D is the outside diameter of the tire and C0 is the circumferential length of the laden contact surface area.

Advantageously, with the outer radial portion of the at least one outer longitudinal cut extending radially inwards down to a radial depth DE1, each outer transverse cut has an outer radial portion having a height HTE1 at least equal to HE1, a mean width WTE1 at least equal to 0.6*HTE1, preferably at least equal to WE1, and a depth DTE1 at least equal to DE1. Said outer transverse cut outer radial portion is consequently an effective groove with a height and depth at least equal to those of the outer radial portion of the outer longitudinal cut, but with an at least equal width, so as to ensure a rate of lateral removal at least equal to the rate of longitudinal removal.

Also advantageously, each outer transverse cut has an inner radial portion that opens into its outer radial portion and has a height HTE2 and a mean width WTE2 at most equal to 0.2 times the height HTE2. Consequently, each outer transverse cut has an inner radial portion of the sipe type connected to the inner radial portion of the sipe type of the outer longitudinal cut.

With the tire having an outside diameter D, measured in the equatorial plane, and an unladen contact surface area having a circumferential length C1 when the tire mounted on a nominal rim is inflated to a nominal pressure Pn and compressed under a load equal to around 0.25*Zn, the at least one inner longitudinal cut is advantageously connected to at least NI inner transverse cuts that open out at an axial end of the tread, NI being at least equal to Π*D/C1, such that the unladen contact surface area comprises at least one inner transverse cut.

Each inner longitudinal cut makes it possible, by way of its inner radial portion, to remove the water and the mud that may be present on the ground, along the circumferential direction, when the tire is fitted to the rear axle of the unladen vehicle, for a state of wear at least at the bottom of the outer radial portion of the outer longitudinal cut. In addition to this longitudinal removal, each inner longitudinal cut is connected to a set of transverse cuts referred to as inner transverse cuts, which have the function of ensuring lateral removal of the water and the mud, at lateral edges of the tread, usually referred to as shoulders. However, this lateral removal requires the presence of at least one such inner transverse cut opening into the unladen contact surface area. This minimum presence is ensured by a regular circumferential distribution, but not necessarily at a constant spacing, of NI inner transverse cuts, where NI is at least equal to Π*D/C1, where D is the outside diameter of the tire and C1 is the circumferential length of the unladen contact surface area.

Advantageously, with the inner radial portion of the at least one inner longitudinal cut extending radially inwards down to a radial depth DI2, each inner transverse cut has an inner radial portion having a height HTI2 at least equal to HI2, a mean width WTI2 at least equal to 0.6*HTI2, preferably at least equal to WI2, and a depth DTI2 at least equal to DI2. Said inner transverse cut inner radial portion is consequently an effective groove with a height and depth at least equal to those of the inner radial portion of the inner longitudinal cut, but with an at least equal width, so as to ensure a rate of lateral removal at least equal to the rate of longitudinal removal.

Also advantageously, each inner transverse cut has an outer radial portion that opens onto the tread surface and into its inner radial portion and has a height HTI1 and a mean width WTI1 at most equal to 0.2 times the height HTI1. Consequently, each inner transverse cut has an outer radial portion of the sipe type connected to the outer radial portion of the sipe type of the outer longitudinal cut.

The or each outer longitudinal cut has a mean line positioned, with respect to the equatorial plane of the tire, at an axial distance LE at most equal to 0.8*L0/2. This upper limit makes it possible to ensure a sufficient width, for each tread lateral end portion, with respect to tread edge wear.

The or each inner longitudinal cut also advantageously has a mean line positioned, with respect to the equatorial plane of the tire, at an axial distance LI at least equal to 0.15*L0/2. This lower limit makes it possible to ensure a sufficient width, for the tread median portion, with respect to resistance to attack.

The difference between the axial distance LE and the axial distance LI is also advantageously at least equal to 0.2*L0/2, preferably at least equal to 0.3*L0/2. This feature ensures a balanced distribution of the respectively outer and inner longitudinal cuts across the width of the tread, and therefore a balanced distribution of the pressures in the contact surface area, and, consequently, more uniform wear across the width of the tread.

With the tread having a volumetric void ratio TEV equal to the ratio between the total volume VD of the cuts, measured on the free tire, i.e. when it is not mounted and not inflated, and the sum of the total volume VD of the cuts and the total volume VR of the raised elements delimited by these cuts, at any level of wear between the new state corresponding to a maximum cut depth D0 and a worn state corresponding to a maximum cut depth DR at least equal to D0/10 and at most equal to D0/3, preferably at most equal to D0/4, the volumetric void ratio TEV is at least equal to 12%, preferably at least equal to 14%. A minimum volumetric void ratio TEV of 12%, preferably of 14%, at any level of wear in the required range, is necessary for the storage and removal or the water or muddy mixture that may be present on the ground being driven on.

With the tread having a volumetric void ratio TEV equal to the ratio between the total volume VD of the cuts, measured on the free tire, i.e. when it is not mounted and not inflated, and the sum of the total volume VD of the cuts and the total volume VR of the raised elements delimited by these cuts, at any level of wear between the new state corresponding to a maximum cut depth D0 and a worn state corresponding to a maximum cut depth DR at least equal to D0/10 and at most equal to D0/3, preferably at most equal to D0/4, the volumetric void ratio TEV is also preferably at most equal to 20%, preferably at most equal to 18%. A maximum volumetric void ratio TEV of 20%, preferably of 18%, at any level of wear in the required range, is necessary to ensure a sufficient volume of rubber compound in relation to the wearing of the tread.

With the tread having a surface-area void ratio TES equal to the ratio between the total surface area SD of the cuts and the sum of the total surface area SD of the cuts and the total surface area SR of the raised elements delimited by these cuts, the surface areas SD and SR being determined in the contact surface area, at any level of wear between the new state corresponding to a maximum cut depth D0 and a worn state corresponding to a maximum cut depth DR at least equal to D0/10 and at most equal to D0/3, preferably at most equal to D0/4, the surface-area void ratio TES is preferably at least equal to 10%, preferably at least equal to 13%. A minimum surface-area void ratio TES of 10%, preferably of 13%, at any level of wear in the required range, makes it possible to ensure a number of edge corners of the cuts opening into the tread surface, in relation to effective indentation of the ground, and therefore of grip.

With the tread having a surface-area void ratio TES equal to the ratio between the total surface area SD of the cuts and the sum of the total surface area SD of the cuts and the total surface area SR of the raised elements delimited by these cuts, the surface areas SD and SR being determined in the contact surface area, at any level of wear between the new state corresponding to a maximum cut depth D0 and a worn state corresponding to a maximum cut depth DR at least equal to D0/10 and at most equal to D0/3, preferably at most equal to D0/4, the surface-area void ratio TES is also preferably at most equal to 24%, preferably at most equal to 20%. A maximum surface-area void ratio TES of 24%, preferably of 20%, at any level of wear in the required range, makes it possible to ensure a sufficient laden and a sufficient unladen contact surface area, bringing about limited contact pressures and, consequently, limited wear.

With the tread having, at any level of wear, a volumetric void ratio TEV equal to the ratio between the total volume VD of the cuts, measured on the free tire, i.e. when it is not mounted and not inflated, and the sum of the total volume VD of the cuts and the total volume VR of the raised elements delimited by these cuts, and a surface-area void ratio TES equal to the ratio between the total surface area SD of the cuts and the sum of the total surface area SD of the cuts and the total surface area SR of the raised elements delimited by these cuts, the surface areas SD and SR being determined in the contact surface area, the TEV/TES ratio is preferably at least equal to 0.8, on average between a new state corresponding to a maximum cut depth D0 and a worn state of the tire corresponding to a maximum cut depth DR at least equal to D0/10 and at most equal to D0/3, preferably at most equal to D0/4. The inventors have sought to achieve the highest possible TEV/TES ratio, both by maximizing the volumetric void ratio TEV, in relation to the grip on wet or muddy ground by aiming for effective storage and removal of the water or the muddy mixture, and by minimizing the surface-area void ratio TES, in relation to the wear by seeking to achieve the largest possible contact surface area.

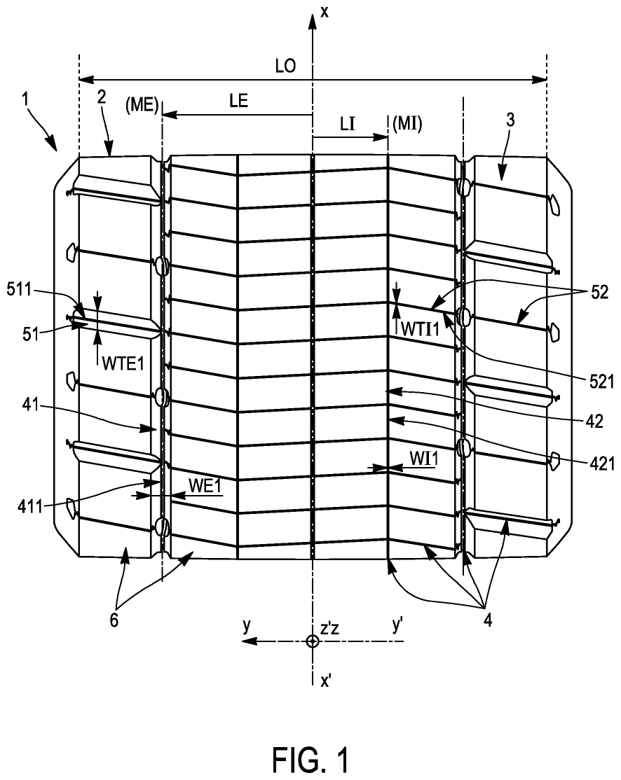

The features of the invention are illustrated by the schematic FIGS. 1 to 12, which are not drawn to scale:

FIG. 1: Top view of a tread portion of a tire according to the invention, in the new state (maximum cut depth D0),

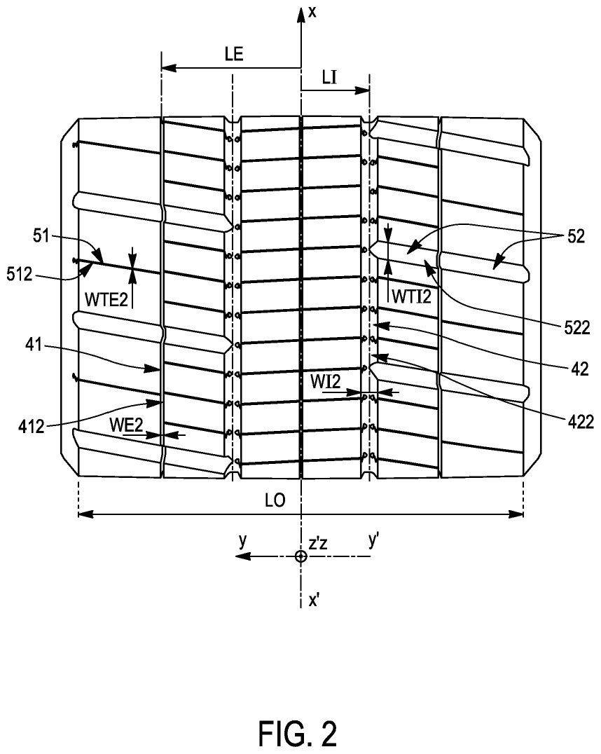

FIG. 2: Top view of a tread portion of a tire according to the invention, in the worn state at 2/3 wear (maximum cut depth D0/3),

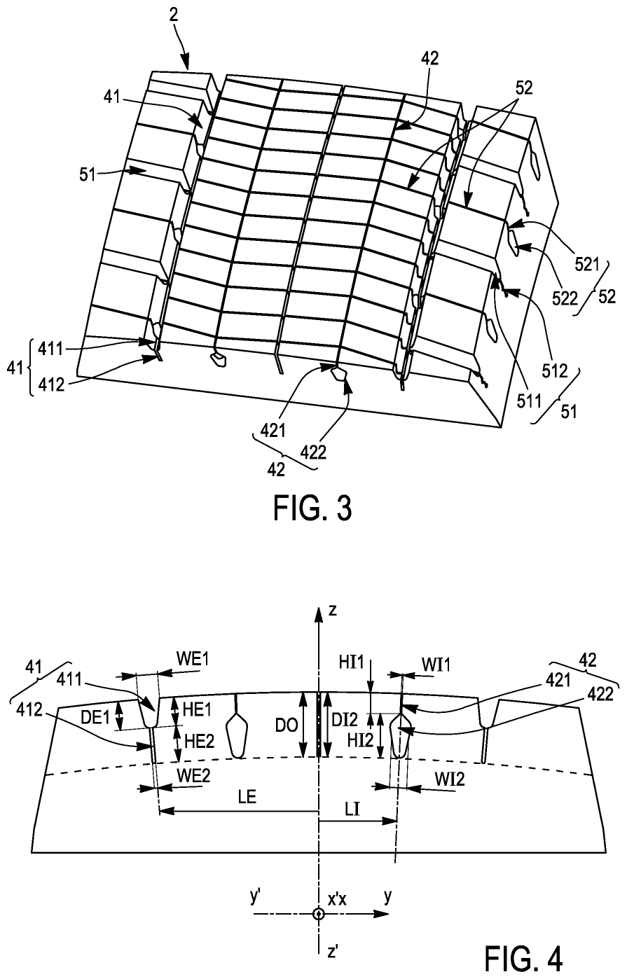

FIG. 3: Perspective view of a tread portion of a tire according to the invention, in the new state,

FIG. 4: Meridian section through the tread of a tire according to the invention, in the new state,

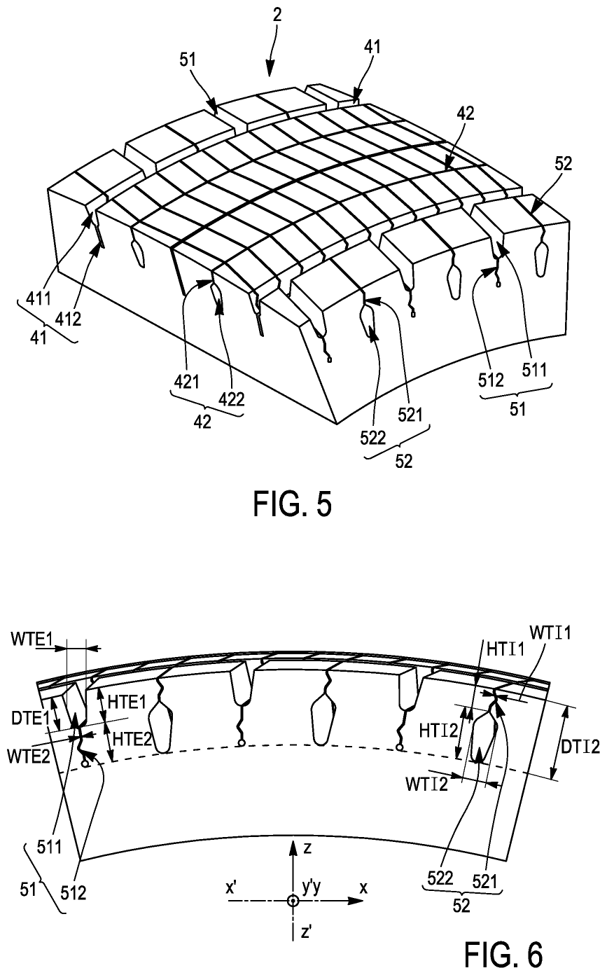

FIG. 5: Perspective view of a tread portion of a tire according to the invention, in the new state,

FIG. 6: Side view of a tread portion of a tire according to the invention, in the new state,

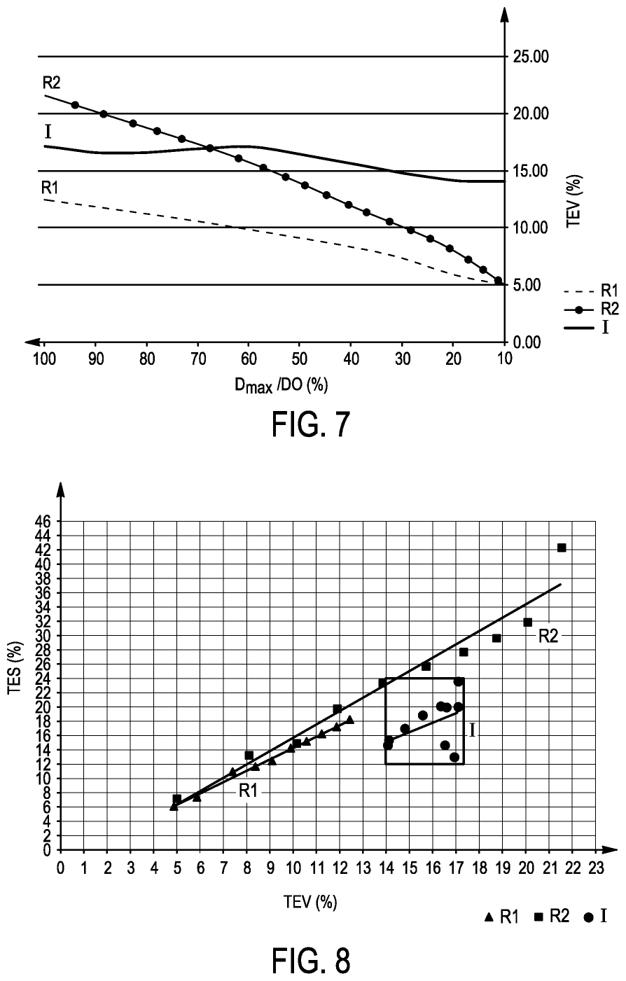

FIG. 7: Change in the volumetric void ratio TEV (in %) as a function of the maximum cut depth Dmax (in % of the maximum cut depth D0, in the new state), for a tire I according to the invention and for two references tires R1 and R2 of the prior art,

FIG. 8: Change in the surface-area void ratio TES (in %) as a function of the volumetric void ratio TEV (in %), for a tire I according to the invention and for two references tires R1 and R2 of the prior art,

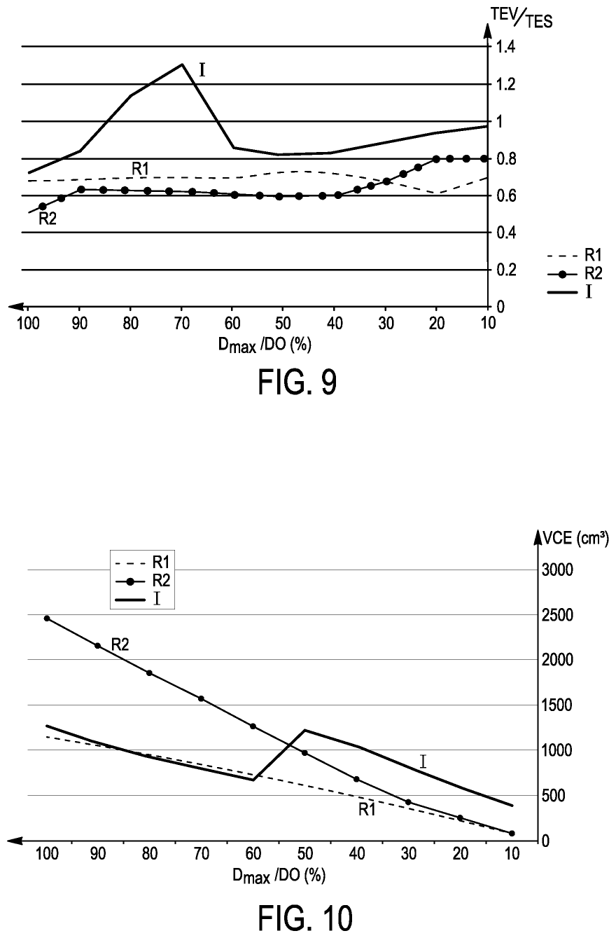

FIG. 9: Change in the ratio of the volumetric void ratio and surface-area void ratio TEV/TES as a function of the maximum cut depth Dmax (in % of the maximum cut depth D0, in the new state), for a tire I according to the invention and for two references tires R1 and R2 of the prior art,

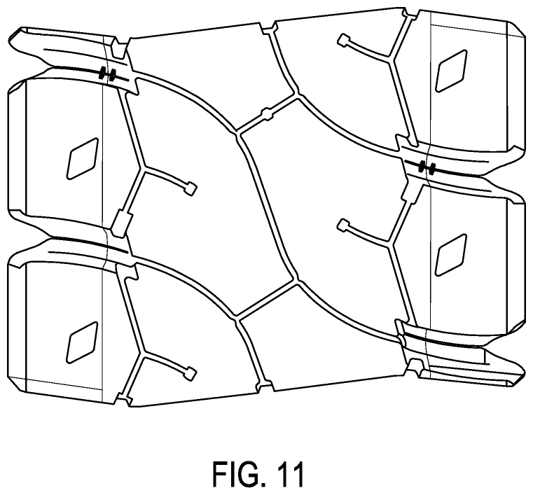

FIG. 10: Change in the total volume of the effective grooves VCE, opening onto the tread, in a given state of wear, as a function of the maximum cut depth Dmax (in % of the maximum cut depth D0, in the new state), for a tire I according to the invention and for two references tires R1 and R2 of the prior art,

FIG. 11: Top view of a tread portion of a reference tire R1, in the new state (Michelin 24.00 R 35 XTRA LOAD PROTECT range),

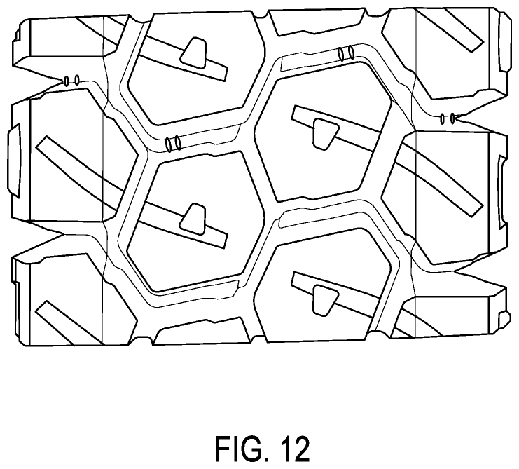

FIG. 12: Top view of a tread portion of a reference tire R2, in the new state (Michelin 24.00 R 35 XTRA LOAD GRIP range).

FIG. 1 is a top view of a tread portion 2 of a tire 1 according to the invention, in the new state, having a maximum cut depth D0 (not shown). This tire 1 for a heavy vehicle of construction plant type comprises, in a new state before it is driven on, a tread 2, which is intended to come into contact with the ground via a tread surface 3. The tread surface 3 has an axial width L0 when the tire mounted on a nominal rim is inflated to a nominal pressure Pn and compressed under a nominal load Zn. The tread surface 3 has an axial width L1 (not shown) when the tire mounted on a nominal rim is inflated to a nominal pressure Pn and compressed under a load equal to around 0.25*Zn. The tread 2 comprises cuts 4 that separate raised elements 6 and have a maximum depth D0 (not shown). The tread 2 comprises, on each side of an equatorial plane XZ, an outer longitudinal cut 41 having a mean line ME positioned, with respect to an equatorial plane XZ of the tire, at an axial distance LE at least equal to 0.5*L0/2, and an inner longitudinal cut 42 having a mean line MI, positioned with respect to the equatorial plane XZ of the tire, at an axial distance LI at most equal to 0.4*L0/2. In the following text, the cuts are described in the new state. The outer longitudinal cut 41 comprises an outer radial portion 411 of the groove type having a mean width WEE Moreover, the outer longitudinal cut 41 is connected to outer transverse cuts 51, each comprising an outer radial portion 511 of the groove type having a mean width WTE1. The inner longitudinal cut 42 comprises an outer radial portion 421 of the sipe type having a mean width WI1. Moreover, the inner longitudinal cut 42 is connected to inner transverse cuts 52, each comprising an outer radial portion 521 of the sipe type having a mean width WTI1.

FIG. 2 is a top view of a tread portion 2 of a tire 1 according to the invention, in the worn state at 2/3 wear, in which the maximum cut depth Dmax is equal to D0/3 (not shown). Some of the references in FIG. 1 are repeated in FIG. 2. In the following text, the cuts are described in a worn state, typically at 2/3 wear. The outer longitudinal cut 41 comprises an inner radial portion 412 of the sipe type having a mean width WE2. Moreover, the outer longitudinal cut 41 is connected to outer transverse cuts 51, each comprising an inner radial portion 512 of the sipe type having a mean width WTE2. The inner longitudinal cut 42 comprises an inner radial portion 422 of the groove type having a mean width WI2. Moreover, the inner longitudinal cut 42 is connected to inner transverse cuts 52, each comprising an inner radial portion 522 of the groove type having a mean width WTI2.

FIG. 3 is a perspective view of a tread portion 2 of a tire according to the invention, in the new state, in which the perspective angle reveals more particularly the system of longitudinal cuts (41, 41).

FIG. 4 is a meridian section associated with FIG. 3, describing the system of longitudinal cuts (41, 42). According to the invention, the outer longitudinal cut 41 comprises an outer radial portion 411 that opens onto the tread surface 3 and has a height HE1 and a mean width WE1 at least equal to 0.6 times the height HE1, that is to say an effective groove, and the inner longitudinal cut 42 comprises an inner radial portion 422 that does not open onto the tread surface 3, extends at least partially radially on the inside of the outer radial portion 411 of the outer longitudinal cut 41, and has a height HI2 and a mean width WI2 at least equal to 0.6 times the height HI2, that is to say likewise an effective groove. There is thus generally, but not necessarily, a radial overlap between the bottom of the outer radial portion 411 of the outer longitudinal cut 41, of the effective groove type, and the top of the inner radial portion 422 of the inner longitudinal cut 42, likewise of the effective groove type. Advantageously, the outer radial portion 411 of the outer longitudinal cut 41 has a mean width WE1 at most equal to 2 times its height HE1, preferably at most equal to its height HE1. In addition, the outer radial portion 411 of the outer longitudinal cut 41 extends radially inwards down to a radial depth DE1, advantageously at least equal to D0/4, preferably at least equal to D0/3, and also advantageously at most equal to 2*D0/3, preferably at most equal to D0/2. Lastly, the outer longitudinal cut 41 comprises preferably an inner radial portion 412 that opens into its outer radial portion 411 and has a height HE2 and a mean width WE2 at most equal to 0.2 times the height HE2, that is to say a sipe that does not open onto the tread surface in the new state. Advantageously, the inner radial portion 422 of the inner longitudinal cut 42 has a mean width WI2 at most equal to 2 times its height HI2, preferably at most equal to its height HI2. In addition, the inner radial portion 422 of the inner longitudinal cut 42 extends radially inwards down to a radial depth DI2 advantageously at least equal to D0/2, preferably at least equal to 2*D0/3, and also advantageously at most equal to D0, preferably at most equal to 9*D0/10 and even more preferably at most equal to 3*D0/4. Preferably, the inner longitudinal cut 42 comprises an outer radial portion 421 that opens onto the tread surface 3 and into its inner radial portion 422 and has a height HI1 and a mean width WI1 at most equal to 0.2 times the height HI1, that is to say a sipe that opens onto the tread surface in the new state.

FIG. 5 is a perspective view of a tread portion 2 of a tire according to the invention, in the new state, in which the perspective angle reveals more particularly the system of transverse cuts (51, 52).

FIG. 6 is a side view associated with FIG. 5, describing the system of transverse cuts (51, 52). Advantageously, with the tire having an outside diameter D (not shown), measured in the equatorial plane YZ, and a laden contact surface area having a circumferential length C0 (not shown) when the tire mounted on a nominal rim is inflated to a nominal pressure Pn and compressed under a nominal load Zn, the outer longitudinal cut 41 is connected to at least NE outer transverse cuts 51 that open out at an axial end of the tread 2, NE being at least equal to Π*D/C0, such that the laden contact surface area comprises at least one outer transverse cut. Also advantageously, with the tire having an unladen contact surface area having a circumferential length C1 (not shown) when the tire mounted on a nominal rim is inflated to a nominal pressure Pn and compressed under a load equal to around 0.25*Zn, the inner longitudinal cut 42 is connected to at least NI inner transverse cuts 52 that open out at an axial end 21 of the tread 2, NI being at least equal to Π*D/C1, such that the unladen contact surface area in contact with the ground comprises at least one inner transverse cut. Each outer transverse cut 51 preferably comprises an outer radial portion 511 having a height HTE1 equal to HE1, a mean width WTE1 at least equal to 0.6*HTE1, preferably at least equal to WE1, and a depth DTE1 equal to DEL1. Consequently, this outer radial portion 511 is an effective groove, having the same height and depth as the outer radial portion 411 of the outer longitudinal cut 41 to which it is connected, and an at least equal mean width, in order to ensure a rate of removal of water or muddy mixture that is at least as high as that of the outer longitudinal cut 41. Advantageously, each outer transverse cut 51 has an inner radial portion 512 that opens into its outer radial portion 511 and has a height HTE2 and a mean width WTE2 at most equal to 0.2 times the height HTE2, that is to say a non-open sipe in the new state that is connected to the inner radial portion 412 of the outer longitudinal cut 41. Analogously, each inner transverse cut 52 comprises preferably an inner radial portion 522 having a height HTI2 equal to HI2, a mean width WTI2 at least equal to 0.6*HTI2, preferably at least equal to WI2, and a depth DTI2 equal to DI2. Consequently, this inner radial portion 522 has the same height and depth as the inner radial portion 422 of the inner longitudinal cut 42 to which it is connected, and an at least equal mean width, in order to ensure a rate of removal of water or muddy mixture that is at least as high as that of the inner longitudinal cut 42. Advantageously, each inner transverse cut 52 has an outer radial portion 521 that opens onto the tread surface and into its inner radial portion 522 and has a height HTI1 and a mean width WTI1 at most equal to 0.2 times the height HTI1, that is to say a non-open sipe in the new state that is connected to the outer radial portion 421 of the inner longitudinal cut 42.

FIG. 7 presents the change in the volumetric void ratio TEV (in %) as a function of the maximum cut depth Dmax (in % of the maximum cut depth D0 in the new state), for a tire I according to the invention and for two references tires R1 and R2 of the prior art. The maximum cut depth D0 in the new state is the base 100 of the abscissa axis of the graph. The ratio Dmax/D0 defines a given state of wear of the tread. For the tire I according to the invention, the volumetric void ratio TEV decreases slightly, on average from 17.5% in the new state, with Dmax equal to D0, to 14% in the completely worn state, with Dmax equal to D0/D10. For the reference tire R1 of the prior art, corresponding to the Michelin 24.00 R 35 XTRA LOAD PROTECT range, oriented towards protection against attack with a tread that is more closed in its median part in the new state, the volumetric void ratio TEV decreases from 12.5% in the new state, with Dmax equal to D0, to 5% in the completely worn state, with Dmax equal to D0/10. Lastly, for the reference tire R2 of the prior art, corresponding to the Michelin 24.00 R 35 XTRA LOAD GRIP range, oriented towards grip with a tread that is more open across its entire axial width, the volumetric void ratio TEV decreases from 22% in the new state, with Dmax equal to D0, to 5% in the completely worn state, with Dmax equal to D0/10. Consequently, a tire according to the invention has the advantage of having a substantially constant volumetric void ratio TEV, and therefore a capacity to remove water or muddy mixture that is substantially constant throughout the lifetime of the tire, in all its states of wear.

FIG. 8 presents the change in the surface-area void ratio TES (in %) as a function of the volumetric void ratio TEV (in %), for a tire I according to the invention and for two references tires R1 and R2 of the prior art. For the tire I according to the invention, the volumetric void ratio TEV varies between 14% and 17.5% as shown above, and the surface-area void ratio TES varies between 12% and 24%. For the reference tire R1 of the prior art, corresponding to the Michelin 24.00 R 35 XTRA LOAD PROTECT range, the volumetric void ratio TEV varies between 5% and 12.5% as shown above, and the surface-area void ratio TES varies between 6% and 18%. For the reference tire R2 of the prior art, corresponding to the Michelin 24.00 R 35 XTRA LOAD GRIP range, the volumetric void ratio TEV varies between 5% and 22% as shown above, and the surface-area void ratio TES varies between 7% and 42%. Consequently, the respective ranges of variations of the volumetric void ratio TEV and of the surface-area void ratio TES are much narrower for the tire I according to the invention, resulting in durability of the performance aspects of grip and wear of the tire throughout its lifetime.

FIG. 9 presents the change in the ratio of the volumetric void ratio and surface-area void ratio TEV/TES as a function of the maximum cut depth Dmax (in % of the maximum cut depth D0, in the new state), for a tire I according to the invention and for two references tires R1 and R2 of the prior art. For the tire I according to the invention, the TEV/TES ratio varies between 0.75 and 1.3. For the reference tire R1 of the prior art, corresponding to the Michelin 24.00 R 35 XTRA LOAD PROTECT range, the TEV/TES ratio varies between 0.6 and 0.75. For the reference tire R2 of the prior art, corresponding to the Michelin 24.00 24.00 R 35 XTRA LOAD GRIP range, the TEV/TES ratio varies between 0.5 and 0.8. Consequently, the tire I according to the invention has a TEV/TES ratio that is always greater than that of the tires R1 and R2. This somewhat higher TEV/TES ratio is obtained both by maximizing the volumetric void ratio TEV, in relation to the grip on wet or muddy ground by aiming for effective storage and removal of the water or the muddy mixture, and by minimizing the surface-area void ratio TES, in relation to the wear by seeking to achieve the largest possible contact surface area.

FIG. 10 presents the change in the total volume of the effective grooves VCE, opening onto the tread, in a given state of wear, as a function of the maximum cut depth Dmax (in % of the maximum cut depth D0, in the new state), for a tire I according to the invention and for two references tires R1 and R2 of the prior art. It is apparent from the graph that, in the part beyond half-wear, that is to say for a ratio Dmax/D0 less than 50%, the tread of a tire I according to the invention, with a total volume of effective grooves VCE greater than those of the respective treads of the two reference tires R1 and R2, provides a greater volume for storing the water or mud present on the ground. It will be noted, however, that, for a ratio Dmax/D0 greater than 50%, the total volumes of effective grooves VCE are very similar for the tires I and R1, meaning that these two tires have treads ensuring equivalent storage volumes, before the tire is half-worn, and therefore equivalent grip performance.

FIG. 11 shows a top view of a tread portion of a reference tire R1, in the new state (Michelin 24.00 R 35 XTRA LOAD PROTECT range). The tread pattern is more closed in a median portion, meaning that it comprises narrow longitudinal and transverse grooves that guarantee a volume of material to be worn down and protects against attack, and more open in the two lateral portions that continue the median portion, meaning that it comprises in each case transverse grooves that open onto the edges of the tread, for the at least partial removal of the water or muddy mixture. In this design, the performance aspects of lifetime in terms of wear and of resistance to attack have been prioritized over grip. More specifically, only the transverse grooves that open onto the edges of the tread, with a width equal to 45 mm and a height equal to 74 mm, are effective. The other grooves in the median portion have a width equal to 7 mm and a maximum height equal to 60 mm, meaning that they are closed in the contact surface area, regardless of whether the vehicle is unladen or laden.

FIG. 12 shows a top view of a tread portion of a reference tire R2, in the new state (Michelin 24.00 R 35 XTRA LOAD GRIP range). The tread pattern, referred to as open, comprises, in a median portion and in the two lateral portions that continue it, a network of wide longitudinal and transverse grooves that make it possible to capture mud over the entire tread surface and to remove it at least partially via transverse grooves that open out at the edges of the tread. More specifically, the substantially longitudinal grooves do not comply with the criterion of effectiveness of a groove (W>0.6*H). Specifically, the longitudinal groove of the median portion has a width equal to 21 mm and a height equal to 44 mm, and the longitudinal groove of each lateral portion has a width equal to 37 mm and a height equal to 70 mm Only the transverse grooves comply with the criterion of effectiveness of a groove, with a width equal to 44 mm and a height equal to 74 mm, in each lateral portion, and a width equal to 48 mm and a height equal to 67 mm, in the median portion.

The invention was studied more particularly in the case of a tire for a construction plant vehicle of the dumper type of size 24.00R35, but is applicable to sizes of, for example, between the size 18.00R33 and the size 59/80 R63.

Table 1 below presents the characteristics of the example studied by the inventors:

TABLE 1

| Characteristics | Characteristic values | | Comments |
|---|---|---|---|
| Axial width L0 of the laden | 600 | mm | |
| contact surface area (under | | | |
| Pn and Zn) | | | |
| Circumferential length C0 | 575 | mm | |
| of the laden contact surface | | | |
| area (under Pn and Zn) | | | |
| Axial width L1 of the | 460 | mm | |
| unladen contact surface | | | |
| area (under Pn and | | | |
| 0.25*Zn) | | | |
| Circumferential length C1 | 309 | mm | |
| of the unladen contact | | | |
| surface area (under Pn and | | | |
| 0.25*Zn) | | | |
| Maximum cut depth in the | 72 | mm | |
| new state D0 | | | |
| Axial distance LE of the | 195 | mm | Greater than 0.5*L0/2 = 150 mm |
| outer longitudinal cut 41 | | | Less than 0.8*L0/2 = 240 mm |
| Axial distance LI of the | 96 | mm | Less than 0.4*L0/2 = 120 mm |
| inner longitudinal cut 42 | | | Greater than 0.15*L0/2 = 45 mm |
| Width WE1 of the outer | 24 | mm | Greater than 0.6*HE1 = 21 mm |
| radial portion 411 of the | | | Less than HE1 = 35 mm |
| outer longitudinal cut 41 | | | |
| Height HE1 of the outer | 35 | mm | |
| radial portion 411 of the | | | |
| outer longitudinal cut 41 | | | |
| Depth DE1 of the outer | 35 | mm | Greater than D0/3 = 24 mm |
| radial portion 411 of the | | | |
| outer longitudinal cut 41 | | | |
| Width WE2 of the inner | 2 | mm | Less than 0.2*HE2 = 7.4 mm |
| radial portion 412 of the | | | |
| outer longitudinal cut 41 | | | |
| Height HE2 of the inner | 37 | mm | |
| radial portion 412 of the | | | |
| outer longitudinal cut 41 | | | |
| Width WII of the outer | 2 | mm | Less than 0.2*HI1 = 6.4 mm |
| radial portion 421 of the | | | |
| inner longitudinal cut 42 | | | |
| Height HI1 of the outer | 32 | mm | |
| radial portion 421 of the | | | |
| inner longitudinal cut 42 | | | |
| Width WI2 of the inner | 24 | mm | Equal to 0.6*HI2 = 24 mm |
| radial portion 422 of the | | | Less than HI2 = 40 mm |
| inner longitudinal cut 42 | | | |
| Height HI2 of the inner | 40 | mm | |
| radial portion 422 of the | | | |
| inner longitudinal cut 42 | | | |
| Depth DI2 of the inner | 72 | mm | Greater than 2*D0/3 = 48 mm |
| radial portion 422 of the | | | |
| inner longitudinal cut 42 | | | |
| Width WTE1 of the outer | 26 | mm | Greater than 0.6*HTE1 = 21 mm |
| radial portion 511 of the | | | Less than HTE1=35 mm |
| outer transverse cut 51 | | | |
| Height HTE1 of the outer | 35 | mm | Equal to HE1 = 35 mm |
| radial portion 511 of the | | | |
| outer transverse cut 51 | | | |
| Depth DTE1 of the outer | 35 | mm | Less than D0/2 = 36 mm |
| radial portion 511 of the | | | |
| outer transverse cut 51 | | | |
| Width WTE2 of the inner | 1.2 | mm | Less than 0.2*HE2 =7.4 mm |
| radial portion 512 of the | | | |
| outer transverse cut 51 | | | |
| Height HTE2 of the inner | 37 | mm | |
| radial portion 512 of the | | | |
| outer transverse cut 51 | | | |
| Width WTI1 of the outer | 1.2 | mm | Less than 0.2*HTI1 = 6.4 mm |
| radial portion 521 of the | | | |
| inner transverse cut 52 | | | |
| Height HTI1 of the outer | 32 | mm | |
| radial portion 521 of the | | | |
| inner transverse cut 52 | | | |
| Width WTI2 of the inner | 24 | mm | Equal to 0.6*HTI2 = 24 mm |
| radial portion 522 of the | | | Less than HTI2 = 40 mm |
| inner transverse cut 52 | | | |
| Height HTI2 of the inner | 40 | mm | |
| radial portion 522 of the | | | |
| inner transverse cut 52 | | | |
| Depth DTI2 of the inner | 72 | mm | Equal to DI2 = 72 mm |

| | | |
|---|---|---|
| radial portion 522 of the | | |
| inner transverse cut 51 | | |
| Volumetric void ratio TEV | 17% | Between 12% and 20%, |
| in the new state | | note: Value of TEV equal |
| (Dmax = D0) | | to that of the tire R2 at 1/3 |
| | | wear, corresponding to the |
| | | transfer of the tire from the |
| | | front axle to the rear axle |
| Surface-area void ratio | 23.5% | Between 10% and 24% |
| TES in the new state | | |
| (Dmax = D0) | | |
| TEV/TES ratio in the new | 0.72 | |
| state (Dmax = D0) | | |
| Volumetric void ratio TEV | 15% | Between 12% and 20% |
| at ⅔ wear (Dmax = D0/3) | | |
| Surface-area void ratio | 17% | Between 10% and 24% |
| TES at ⅔ wear | | |
| (Dmax = D0/3) | | |
| TEV/TES ratio at ⅔ wear | 0.88 | |
| (Dmax = D0/3) | | |
| Volumetric void ratio TEV | 14% | Between 12% and 20% |
| at total wear | | |
| (Dmax = D0/10) | | |
| Surface-area void ratio | 14.5% | Between 10% and 24% |
| TES at total wear | | |
| (Dmax = D0/10) | | |
| TEV/TES ratio at total | 0.98 | |
| wear (Dmax = D0/10) | | |

As shown above, in the description of the graph in FIG. 10, the tire I according to the invention is more effective in terms of grip on wet or muddy ground, on account of a volume of effective voids VCE greater than those of the reference tires R1 and R2, especially beyond 50% wear of the tire. However, below 50% wear, the tire I according to the invention and the reference tire R1 have substantially equivalent grip performance.

Moreover, the inventors found that, for the tire I according to the invention, the difference in pressures, measured in the contact surface area in contact with the ground, between the median portion and each lateral portion, was reduced compared with the reference tire R1. This difference in pressures is equal to 1.75 bar for the reference tire R1, whereas it is equal to 1 bar for the tire I according to the invention. In other words, the distribution of the pressures in the contact surface area is more uniform for the tire I according to the invention, thereby ensuring more uniform wear across the axial width of the tread.

1. A tire for a heavy vehicle of construction plant type comprising, in a new state before it is driven on, a tread intended to come into contact with the ground via a tread surface:
the tread surface having an axial width L0 when the tire mounted on a nominal rim is inflated to a nominal pressure Pn and compressed under a nominal load Zn,
the tread comprising cuts that separate raised elements and have a maximum depth D0,
the tread comprising, on each side of an equatorial plane (XZ), at least one outer longitudinal cut having a mean line (ME), positioned with respect to an equatorial plane (XZ) of the tire, at an axial distance LE at least equal to 0.5L0/2, and at least one inner longitudinal cut having a mean line (MI), positioned with respect to the equatorial plane (XZ) of the tire, at an axial distance LI at most equal to 0.4L0/2,
wherein the at least one outer longitudinal cut comprises an outer radial portion that opens onto the tread surface and has a height HE1 and a mean width WE1 at least equal to 0.6 times the height HE1, and in that the at least one inner longitudinal cut comprises an inner radial portion that does not open onto the tread surface, extends at least in part radially on the inside of the outer radial portion of the outer longitudinal cut, and has a height HI2 and a mean width WI2 at least equal to 0.6 times the height HI2.

2. The tire according to claim 1, wherein the outer radial portion of the at least one outer longitudinal cut has a mean width WE1 at most equal to 2 times the height HE1, preferably at most equal to the height HE1.

3. The tire according to claim 1, wherein the outer radial portion of the at least one outer longitudinal cut extends radially inwards down to a radial depth DE1 at least equal to D0/4, preferably at least equal to D0/3.

4. The tire according to claim 1, wherein the outer radial portion of the at least one outer longitudinal cut extends radially inwards down to a radial depth DE1 at most equal to 2*D0/3, preferably at most equal to D0/2.

5. The tire according to claim 1, wherein the at least one outer longitudinal cut comprises an inner radial portion that opens into its outer radial portion and has a height HE2 and a mean width WE2 at most equal to 0.2 times the height HE2.

6. The tire according to claim 1, wherein the inner radial portion of the at least one inner longitudinal cut has a mean width WI2 at most equal to 2 times the height HI2, preferably at most equal to the height HI2.

7. The tire according to claim 1, wherein the inner radial portion of the at least one inner longitudinal cut extends radially inwards down to a radial depth DI2 at least equal to D0/2, preferably at least equal to 2*D0/3.

8. The tire according to claim 1, wherein the inner radial portion of the at least one inner longitudinal cut extends radially inwards down to a radial depth DI2 at most equal to D0.

9. The tire according to claim 1, wherein the at least one inner longitudinal cut comprises an outer radial portion that opens onto the tread surface and into its inner radial portion and has a height HI1 and a mean width WI1 at most equal to 0.2 times the height HI1.

10. The tire according to claim 1, the tire having an outside diameter D, measured in the equatorial plane (YZ), and a laden contact surface area having a circumferential length C0 when the tire mounted on a nominal rim is inflated to a nominal pressure Pn and compressed under a nominal load Zn, wherein the at least one outer longitudinal cut is connected to at least NE outer transverse cuts that open out at an axial end of the tread (2), NE being at least equal to Π*D/C0, such that the laden contact surface area comprises at least one outer transverse cut (51).

11. The tire according to claim 10, the outer radial portion of the at least one outer longitudinal cut extending radially inwards down to a radial depth DE1, wherein each outer transverse cut comprises an outer radial portion having a height HTE1 at least equal to HE1, a mean width WTE1 at least equal to 0.6*HTE1, preferably at least equal to WE1, and a depth DTE1 at least equal to DE1.

12. The tire according to claim 1, the tire having an outside diameter D, measured in the equatorial plane (YZ), and an unladen contact surface area having a circumferential length C1 when the tire mounted on a nominal rim is inflated to a nominal pressure Pn and compressed under a load approximately equal to 0.25*Zn, wherein the at least one inner longitudinal cut is connected to at least NI inner transverse cuts that open out at an axial end of the tread, NI being at least equal to Π*D/C1, such that the unladen contact surface area comprises at least one inner transverse cut.

13. The tire according to claim 12, the inner radial portion of the at least one inner longitudinal cut extending radially inwards down to a radial depth DI2, wherein each inner transverse cut comprises an inner radial portion having a height HTI2 at least equal to HI2, a mean width WTI2 at least equal to 0.6*HTI2, preferably at least equal to WI2, and a depth DTI2 at least equal to DI2.

14. The tire according to claim 1, wherein the at least one outer longitudinal cut has a mean line (ME) positioned, with respect to the equatorial plane (XZ) of the tire, at an axial distance LE at most equal to 0.8*L0/2.

15. The tire according to claim 1, wherein the at least one inner longitudinal cut has a mean line (MI) positioned, with respect to the equatorial plane (XZ) of the tire, at an axial distance LI at least equal to 0.15*L0/2.

16. The tire according to claim 1, wherein the difference between the axial distance LE and the axial distance LI is at least equal to 0.2*L0/2, preferably at least equal to 0.3*L0/2.

17. The tire according to claim 1, the tread having a volumetric void ratio TEV equal to the ratio between the total volume VD of the cuts, measured on the free tire, i.e. when it is not mounted and not inflated, and the sum of the total volume VD of the cuts and the total volume VR of the raised elements delimited by these cuts, wherein, at any level of wear between the new state corresponding to a maximum cut depth D0 and a worn state corresponding to a maximum cut depth DR at least equal to D0/10 and at most equal to D0/3, preferably at most equal to D0/4, the volumetric void ratio TEV is at least equal to 12%, preferably at least equal to 14%.

18. The tire according to claim 1, the tread having a volumetric void ratio TEV equal to the ratio between the total volume VD of the cuts, measured on the free tire, i.e. when it is not mounted and not inflated, and the sum of the total volume VD of the cuts and the total volume VR of the raised elements delimited by these cuts, wherein, at any level of wear between the new state corresponding to a maximum cut depth D0 and a worn state corresponding to a maximum cut depth DR at least equal to D0/10 and at most equal to D0/3, preferably at most equal to D0/4, the volumetric void ratio TEV is at most equal to 20%, preferably at most equal to 18%.

19. The tire according to claim 1, the tread having a surface-area void ratio TES equal to the ratio between the total surface area SD of the cuts and the sum of the total surface area SD of the cuts and the total surface area SR of the raised elements delimited by these cuts, the surface areas SD and SR being determined in the contact surface area, wherein, at any level of wear between the new state corresponding to a maximum cut depth D0 and a worn state corresponding to a maximum cut depth DR at least equal to D0/10 and at most equal to D0/3, preferably at most equal to D0/4, the surface-area void ratio TES is at least equal to 10%, preferably at least equal to 13%.

20. The tire according to claim 1, the tread having a surface-area void ratio TES equal to the ratio between the total surface area SD of the cuts and the sum of the total surface area SD of the cuts and the total surface area SR of the raised elements delimited by these cuts, the surface areas SD and SR being determined in the contact surface area, wherein, between the new state corresponding to a maximum cut depth D0 and a worn state corresponding to a maximum cut depth DR at least equal to D0/10 and at most equal to D0/3, preferably at most equal to D0/4, the surface-area void ratio TES is at most equal to 24%, preferably at most equal to 20%.

21. The tire according to claim 1, the tread having a volumetric void ratio TEV equal to the ratio between the total volume VD of the cuts, measured on the free tire, i.e. when it is not mounted and not inflated, and the sum of the total volume VD of the cuts and the total volume VR of the raised elements delimited by these cuts, and a surface-area void ratio TES equal to the ratio between the total surface area SD of the cuts and the sum of the total surface area SD of the cuts and the total surface area SR of the raised elements delimited by these cuts, the surface areas SD and SR being determined in the contact surface area, wherein the TEV/TES ratio is at least equal to 0.8, on average between a new state corresponding to a maximum cut depth D0 and a worn state of the tire corresponding to a maximum cut depth DR at least equal to D0/10 and at most equal to D0/3, preferably at most equal to D0/4.
